(19) United States
(12) Patent Application Publication
(10) Pub. No.: US 2005/0215082 A1
(43) Pub. Date: Sep. 29, 2005

(54) Disassemble and interchangeable tails for solid boards for nautical sports practice and manufacturing method thereof

(76) Inventor: Fernando Claudio Sardo, Mentevideo (UY)

Correspondence Address: PENDORF & CUTLIFF, 5111 MEMORIAL HIGHWAY, TAMPA, FL, 33634-7356, US

(21) Appl. No.: 11/032,268

(22) Filed: Jan. 10, 2005

(30) Foreign Application Priority Data
Mar. 25, 2004 (UY) U-4007

(51) Int. Cl. H01R 12/00

(52) U.S. Cl. 439/60

(57) ABSTRACT

Two pieces are manufactured in a highly resistant, light and waterproof material which tolerate the prolonged use in the water. The two pieces are assembled tightly in order to generate a body that it is assembled in the back side of any solid board for the practice of nautical sports. Any type of board tail can be shaped in one of said pieces. The board tails are disassemble and interchangeable. The owner of only one board can adapt it to each type of wave, eliminating unnecessary luggage when transporting its equipment to the sports practicing place, bringing several types of board tails instead of several types of boards.

### BACKGROUND OF THE INVENTION

1. Field of the Invention

This invention is related to the manufacturing and shaping of solid boards for nautical sports practice manufactured of any type of highly resistant, light, and waterproof materials, which besides tolerate the prolonged use in the water. This invention is related to the parts or pieces thereof.

2. Related Art of the Invention

In 1900, George Freeth recovered a solid surf board from his Hawaiian ancestors. This kind of solid surf boards was used by the old Hawaiian people to express their religious sense, love or several social events. The board was 4.80 meters long and weighed more than 65 kilos. It was manufactured of wood, in only one piece, and its tail was quite larger than the tails we use to see today.

From the last years of the XX century and the beginning of the XXI century, the solid surf boards that the sportsmen preferred were 1.85 meters long and weighed less than 3 kilos. They were also manufactured in only one piece but of very light materials as for instance polyurethane.

From 1900 up to the 30's, the boards were mostly manufactured of sequoia wood, because in spite of being very heavy they were also very water resistant. To make them lighter, the manufacturers began to make them hollow. The length and the width of the board tree were the parameters that the manufacturers had to take in account in order to manufacture a board that could be used in a proper way. They manufactured big boards near 4 meters long that were not handeable and that did not enable surfers to surf waves higher than one meter high. On the other hand, the turns were very difficult for the sportsmen because the tails were very large.

In the 30's, the Waikiki waves were the surfers meeting point. The surfers needed to get back on the big boards, to press down with one foot and to raise the nose of the boards in order to change the direction.

The surfers tried to surf on waves higher than one meter high practicing on those big boards but the results were continuous falls. In those days, the big surfers as for instance the Hawaiian John Kelly, Fran Heath, or Wally Froiseth, and the Californian Lorrin Harrison and Pete Peterson discovered that it was necessary to modify the boards.

During the 30's the shape of the boards changed widely, particularly the shape of the tails thereof narrowed in order to make the turns easier.

In 1935, Blake invented the board fins. He wanted to make boards faster, easier to handle and more secure. His invention consisted of putting a fin in the back central side of the board. The board waved and the sportsman surfed in balance no more as with the big boards, but improved the handling so the fins were a technical success.

In 1940 and later on two important inventions appeared. Firstly, the sequoia wood is abandoned to prefer the raft wood. On the other hand, the first disassemble fins appear, that is to say that the manufacturing concept changed. The solid board manufactured in only one piece was abandoned to prefer the disassemble board. The shaper gains importance in this period as the technician that the sportsman asked the final shape of his board according to his needs.

The Second World War carried big advances in the nautical industry. The polyurethane foam and the polyester resins substituted the wood for the manufacturing of the solid boards and the fins during the 60's.

During the 50's and the 60's, the manufacturers worked to satisfy the surfers search: a perfect board. The surf evolves to search bigger handling, easier turns, and to adapt to every kind of waves. The manufacturers proposed as solution the reduction of the boards' weigh using the new materials, and changing their manufacturing proceeding. The expansion of the polyurethane foam enabled to turn easier the manufacturing of the boards giving them more definition.

During the 70's and the 80's, the industry tried new materials, almost unbreakable fibers, and specifically shapes for each type of waves involving the tails design.

The addition of these new materials in this industry enabled the expansion of water sports that could be practiced with a board. For instance, windsurf and the fly surf or kite surf were born.

There are different types of tails that could be called big categories, they are: the square tail that it is the one that gives the best floating and it adapts to little waves; the round tail is round, it has a lesser area around the tail fin (the current boards has normally three fins) and it adapts to round waves also called hollow or tubular waves; the round square tail is semicircular and it is considered as the neutral design, the more common; the pintail has a point and gives a good grabbing, stability and sensibility so it is the best for big and hollow waves; the round pin tail is a modification of the square tail, the point is rounded in order to combine the floating of the square tail with the adaptability to the big waves that the pintail has; the fish tail or swallow tail has the same area as the square one and good grabbing in the little and hollow wave wall; the tail in V has a big area the same as the round square tail, good handling and ability for very brusque turns.

The shape of the tails is evolution constantly due to the needs and convenience of the sportsmen, and the changes in the waves types.

The tail corresponds to the approximate last 12 inches of each board. The different types of tails, integrated as a whole with the rest of the board, solv problems that arise during the turns and when handling the board, but mainly each type of tail is designed for each type of wave and according to the convenience of each sportsman.

The manufacturing method of the solid boards involves the inclusion of a specific kind of tail in the same body of the board. There are boards with square tail, others with pin tail, and others with round square tail and so on.

When the sportsman goes to the sporting practice place he has to carry a specific number of boards, each one with a different type of tail. This is not convenient because the luggage to carry is very heavy.

### SUMMARY OF THE INVENTION

One of the problems to solve through the creation of the disassemble and interchangeable tails for solid boards for the practice of nautical sports and manufacturing method thereof it is the said inconvenience. Giving the chance of assembling and disassembling the different types of tails in relation to only one board, the luggage to carry diminishes very much.

A solution to this problem has not yet been disclosed up to this moment because the known technology does not enable to assemble and disassemble tails, and this complies to limit the board's possibilities to its original design.

At the same time, an only one board becomes versatile because the fact of enabling to disassemble one tail and put another one in its place and also enables to adapt one board to the different types of waves according to the needs or preferences of the sportsman, which involves the best using of the board. One can have an indeterminate number of tails for only one board. For instance, it is known that a narrow tail enables to project the board onwards with better direction turning the handlings more secure and stronger; a rounder tail enables smoother and longer handlings, looses the points and leans more centrally when turning the board.

The disassemble and interchangeable tails and manufacturing method thereof disclosed here are able for every kind of board, including the bidirectional ones as the windsurf and kitesurf boards.

For instance, the surfer who has a quite standard board, that is to say a board with proper measures so as it can be used either in big or little waves; he can have several kind of tails for only one board.

Another problem that can be solved with the disassemble and interchangeable tails it is the one that arises with the need of having different water exits according to the different types of waves.

Currently, the boards can be manufactured with three disassemble fins but this does not solve said problem. Although the three disassemble fins were conceived to solve this problem, at present they are mainly considered a convenience whenever the transport of boards is needed.

Instead, the disassemble and interchangeable tails can adapt to a board of the three disassemble fins type, and solve the said problem because they enable to change the edges of the back side of the board whose aim it is to control the turns and the water exit.

In U.S. Pat. No. 6,652,340 a hollow surf board that can be filled with compressed air is disclosed. Although this board has disassemble nose and tail, they are hollow parts with compressed air income valves that can only be used with this specifically type of boards. It is a proposal whose aim it is to diminish the boards' weigh.

Instead, the target of the present invention it is to disclose disassemble and interchangeable tails for solid boards (e.g.: surf boards, windsurf boards, kitesurf) whose aims are, firstly, to diminish the weigh of the luggage that a sportsman has to transport from one beach to another, secondly, to adapt an only one board to the different kinds of waves; and, at last, to have different water exits in an only one board according to the different types of waves.

The inventor does not know disassemble and interchangeable tails as the ones that are disclosed by this document. He does not know a manufacturing method thereof similar to the one disclosed by this document either.

### DESCRIPTION OF THE INVENTION

The disassemble and interchangeable tails for solid boards for nautical sports practice that are disclosed by this document are manufactured with two pieces made of highly resistant, light, less dense than water and waterproof materials, which besides tolerate the prolonged use in the water. One of the pieces is to be fixed to the back side of the board while the other one is disassemble.

The disassemble piece is to be settled to the piece that is fixed to the board. The disassemble piece is shaped in the desired shape. The result is a disassemble and interchangeable tail because this method enables to manufacture different types of tails for an only one board.

The piece that is to be fixed in the board is three-dimensional. Said piece has a segment where a cavity is a female (nut) and where one or more holes, tubes or channels appear so as to enable fastening media to be settled, said fastening media being manufactured in a light and rustproof material. The fastening media will cooperate to set the disassemble piece tightly. The piece with the female cavity is to be fixed to the board thanks to secure media.

The second piece is three-dimensional, disassemble, and bigger than the other described piece. This piece has a male segment that it is to be settled in the female cavity of the other piece.

The disassemble piece can be shaped according to the desired type of tail. The result is a disassemble and interchangeable tail because, using the same manufacturing method, one can create different tails that enable the interchange.

For instance, there are two ways to set the disassemble and interchangeable tails in the boards, one of them consist of adapting the known boards and the other one is to manufacture boards without tails.

In order to adapt the known boards one can cut the tail with the shape of a “V”. Afterwards, the cut section can be sealed with proper materials, as for instance, resin and glass fiber. After this, one can shape two cavities, one at each side of the “V”, setting one piece with female cavity at each one of them. Afterwards, one can set two pieces with male segments one at each side of the “V”.

Besides, boards without tail can be manufactured so as to enable the setting of the pieces with female cavities in their back side. Otherwise, the method is similar to the other situation.

The disassemble and interchangeable tails enable to transport conveniently an indeterminate number of tails for only one board, to adapt the board to the different types of waves, and to change the edges of the back section of the board to improve the turns control and the water exit.

### INDUSTRIAL APPLICATION

The described pieces can be manufactured at an industry rate with the use of moulds for light material.

An Example of Manufacturing

In an example of manufacturing, and without limiting the field of this invention, one can take a solid board able for the practice of nautical activities. One can choose the types of tails desired to be settled.

One cuts a section of the tail shaping a “V”. In each exterior side of the “V”, one makes a cavity in order to set the pieces with female cavities.

The pieces with female cavities are made with semicircular bases. Besides, holes are made to set light and rustproof screws.

Once the cavities that will enable the pieces with female cavities to be settled are made, one seals the cutting areas where the board will contact the pieces mentioned in this document. After this, one applies liquid resin in order to enable to secure the fixation of the semicircular base piece to the board. One puts the semicircular bases pieces with the bases thereof downwards.

The pieces with male segments are settled and fixed with screws to the pieces with female cavities.

The pieces with male segments are shaped taking care of making the correct level in the material so that said pieces, once shaped, compose a tail correctly integrated as a continuation of the board.

Afterwards, a general smoothing is made on the board and on the disassemble and interchangeable tail.

### DESCRIPTION WITH REFERENCE TO THE DRAWINGS

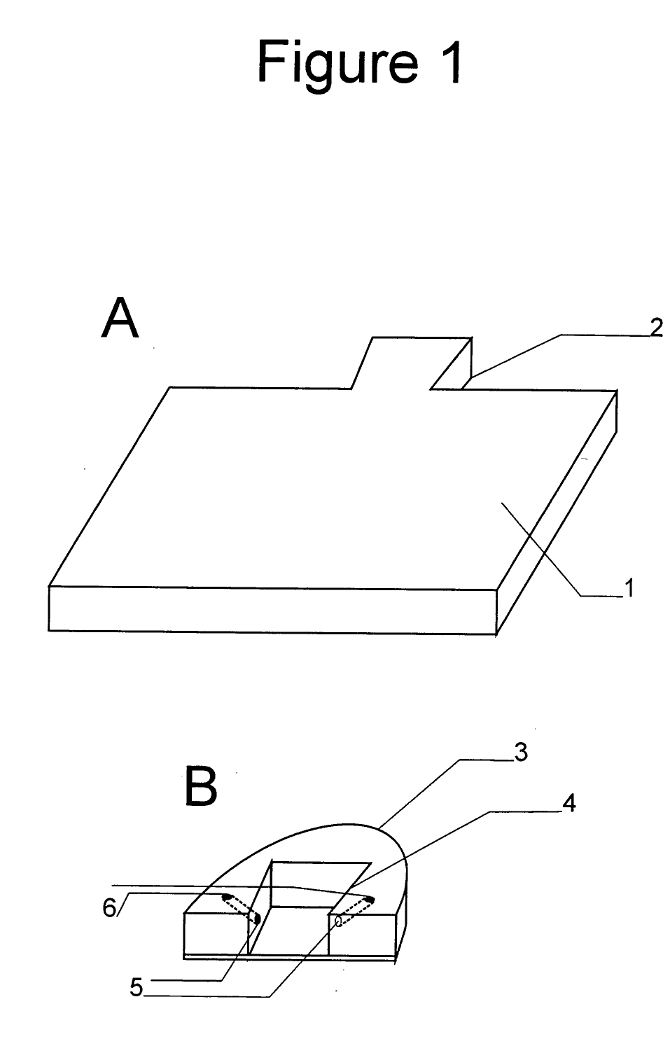

In FIG. 1 two pieces can be seen, one of them it is a solid block (letter A) of rectangular base (1) where the male segment can be seen (2); and a three-dimensional solid piece (letter B) of semicircular base (3) with a female cavity (4) with two holes or tubes where light and rustproof screws are settled (5 and 6).

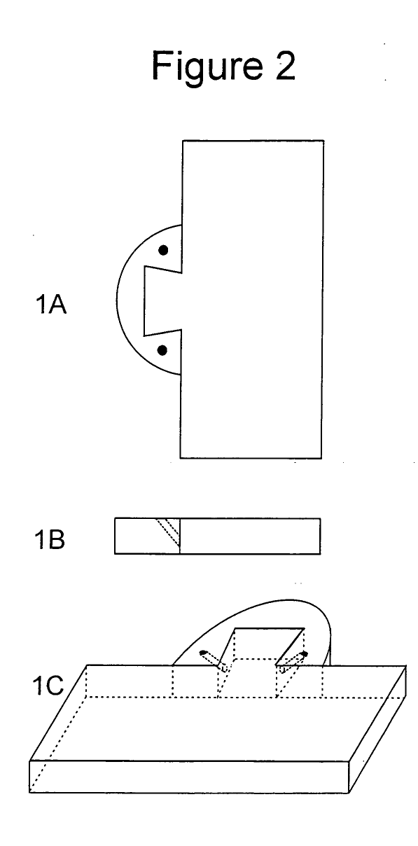

In FIG. 2 the two pieces assembled one to the other can be seen from above (1A), from one side (1B) and from an angle (1C).

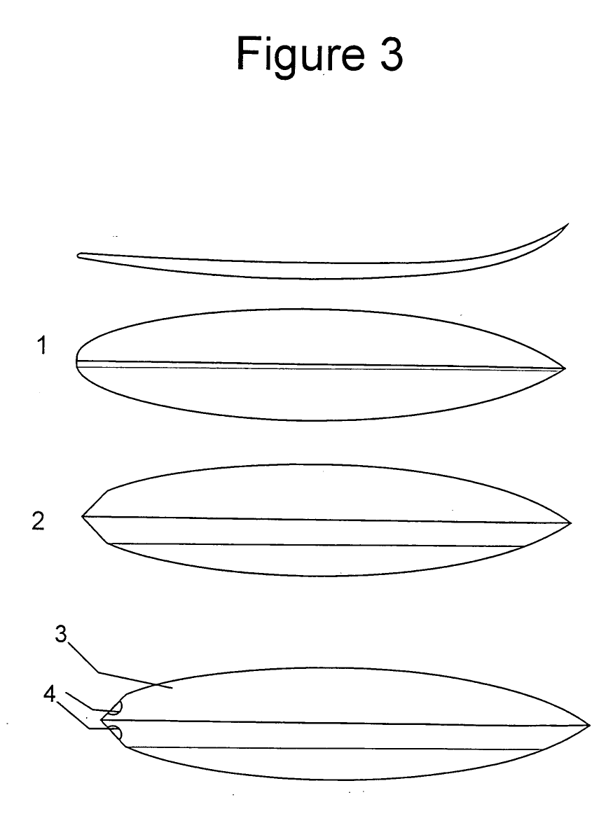

In FIG. 3 a board can be seen from one side and from above (1). A “V” cutting has been made in the board (2) taking away the final part or tail. In 3 a board with a “V” cutting can be seen where cavities 4 for the fixation of the pieces with female cavities can be seen.

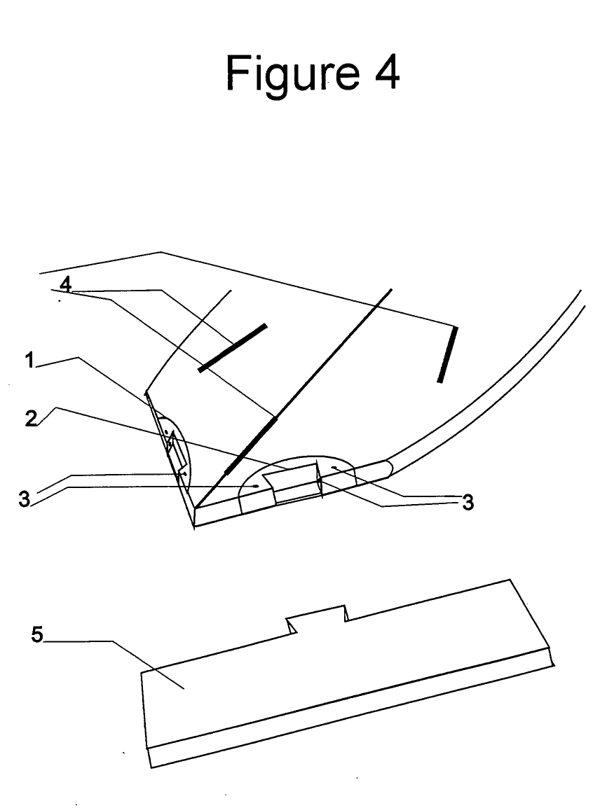

In FIG. 4 the board can be seen from an angle with the three-dimensional pieces with female cavities already assembled (1 and 2) with holes for the fixation screws (3). In order to turn the comprehension easier, number 4 indicates the position of the three fins usually seen in the most common boards. The disassemble piece with male segment (5) is put in front of the piece with female cavity (2).

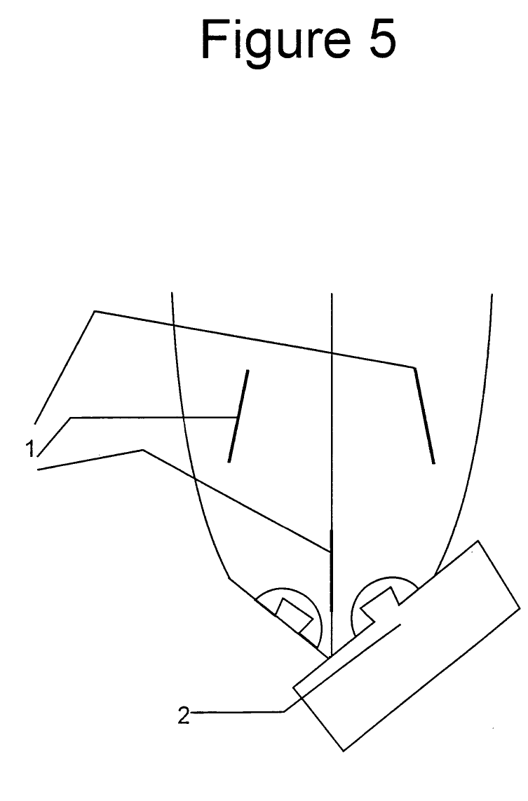

In FIG. 5 a board with three fins is seen from above (1), a piece with male segment is assembled to the board (2).

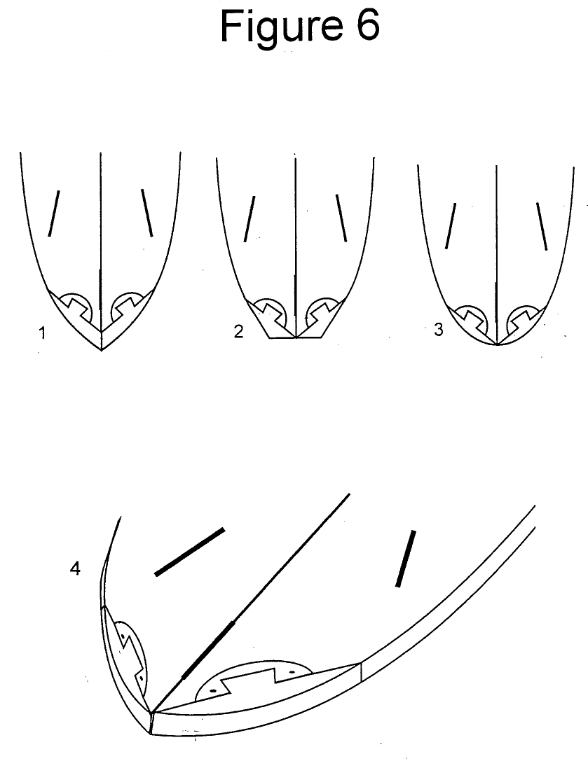

In FIG. 6 the pieces with male segments have been assembled to the boards that can be seen from above. Pintail (1), square tail (2) and round tails (3) have been shaped. In 4 a board with a pintail shaped thereto can be seen from an angle.

1-6. (canceled)

7. A disassemble and interchangeable tail for a solid board for nautical sports practice comprising:
the board having a front side and a back side;
a first piece;
at least one second piece;
wherein the first piece is fixed to the board; and
wherein the at least second piece is connected to the first piece;
wherein the first piece and the second piece form the tail.

8. The disassemble and interchangeable tail according to claim 1, wherein the first piece is three-dimensional and made of a highly resistant, light weight, waterproof material;
wherein the first piece includes a female connection having at least one hole, channel, or tube.

9. A disassemble and interchangeable tail according to claim 2, wherein the female connection is fixed to the back side of the board.

10. The disassemble and interchangeable tail according to claim 8 wherein the at least one second piece is three-dimensional, bigger than the first piece, made of a highly resistant, light weight, waterproof materials, and includes a male connection that matches the female connection of the first piece;
wherein the at least second piece is interchangeable.

11. A method for manufacturing a disassemble and interchangeable tail for solid boards for nautical sports practice comprising:
providing the board having a front side, a back side;
cutting a section on the back side of the board in a “V” shape;
placing a first piece having a female connection in the V shaped section;
sealing the connection between the V shaped section and the first piece;
placing a second piece having a male connection in the female connection of the first piece;
wherein the first piece and the second piece form the tail of the board.
